(19) United States
(12) Patent Application Publication
(10) Pub. No.: US 2003/0039319 A1
(43) Pub. Date: Feb. 27, 2003

(54) Monitoring upstream frequency band

(76) Inventors: Willem Engelse, Schiedam (NL); William Corley, Foxborough, MA (US); David Unger, Windham, NH (US); David Davies, Chelmsford, MA (US); Paul Dormitzer, Acton, MA (US); Raymond Robidoux, Windham, NH (US)

Correspondence Address: LEFFERT JAY & POLGLAZE, P.A., P.O. BOX 581009, MINNEAPOLIS, MN, 55458-1009, US

(21) Appl. No.: 09/935,193

(22) Filed: Aug. 22, 2001

(51) Int. Cl. H04L 27/06; H04B 3/46

(52) U.S. Cl. 375/316; 375/228

(57) ABSTRACT

A spectrum analyzer is provided. The spectrum analyzer includes an input adapted to receive an input signal and a mixer, coupled to the input. The mixer is adapted to produce a down converted signal from the input signal. The spectrum analyzer further includes an adjustable decimation circuit, coupled to the mixer, that selectively decimates the down converted signal, a decoder, coupled to the adjustable decimation circuit, that measures power in the decimated signal, and a control circuit, coupled to the mixer, that selectively controls the frequency of the down converted signals from the mixer to measure power over a frequency spectrum of the input signal.

### TECHNICAL FIELD

The present invention relates generally to the field of electronics and, in particular, to monitoring upstream frequency band.

### BACKGROUND

In the telecommunications industry, the transport of data has become a potential source for increased revenues for many service providers. The need to transport data at high speeds has driven the industry in many different directions. For example, high-speed data services are available from telephone companies using digital subscriber line (DSL) services. Further, the cable industry has developed and deployed cable modems using standards such as the Data Over Cable Service Interface Specifications (DOCSIS) standard.

One problem with the cable industry is the susceptibility of the cable network to noise in the frequency spectrum commonly used to transport data. For example, in the United States, most cable modems transport data from subscribers to a head end of the cable system in the frequency band from 5-45 MHz. Due to noise problems in this band, service providers must monitor the band and make adjustments as necessary to assure that data throughput does not fall below acceptable levels due to noise. This often requires the use of expensive spectrum analyzers to get an accurate picture of the frequencies that are affected by noise in a given cable plant so that those frequencies are not used to carry data. Further, frequencies in the band affected by noise often change over time. Thus, bandwidth allocation based on the use of spectrum analyzers may need to be changed in response to the changing conditions on the communication medium. Unfortunately, conventional processes for monitoring the upstream spectrum are time consuming and do not allow quick reaction to changes in noise in the system. As a result data throughput is often negatively impacted.

For the reasons stated above, and for other reasons stated below which will become apparent to those skilled in the art upon reading and understanding the present specification, there is a need in the art for improvements in monitoring the quality of bandwidth used for upstream communications to allow quick reaction to changes in noise in the spectrum.

### SUMMARY

The above-mentioned problems with spectrum analysis and other problems are addressed by embodiments of the present invention and will be understood by reading and studying the following specification. Embodiments of the present invention advantageously allow quick reaction to changes in noise in the spectrum by embedding circuitry for frequency and/or time domain analysis in the communication circuitry. For example, in one embodiment, this circuitry selectively provides time domain or spectral analysis based on signals in a digital down converter.

In one embodiment, a spectrum analyzer is provided. The spectrum analyzer includes an input adapted to receive an input signal and a mixer coupled to the input. The mixer is adapted to produce a down converted signal from the input signal. The spectrum analyzer further includes an adjustable decimation circuit, coupled to the mixer, that selectively decimates the down converted signal and a decoder, coupled to the adjustable decimation circuit, that measures power in the decimated signal. Further the spectrum analyzer includes a control circuit, coupled to the mixer, that selectively controls the frequency of the down converted signals from the mixer to measure power over a frequency spectrum of the input signal.

In one embodiment, a method for measuring power of an input signal over a selected frequency spectrum is provided. The method includes mixing the input signal to produce a down converted signal at a selected frequency and decimating the down converted signal. The method further includes measuring a power level of the decimated signal and repeating the process of mixing, decimating, measuring and storing to produce power measurements at a plurality of frequencies.

In one embodiment, a signal analyzer is provided. The signal analyzer includes an input adapted to receive an input signal, a mixer, coupled to the input, the mixer adapted to produce a down converted signal from the input signal, and an adjustable decimation circuit, coupled to the mixer, that selectively decimates the down converted signal. The signal analyzer further includes a threshold comparator, coupled to the adjustable decimation circuit, that compares the decimated signal with a selected threshold over a period of time, and a control circuit, coupled to the mixer, that selectively controls the frequency of the down converted signals from the mixer to select a frequency of the input signal for time domain analysis.

In one embodiment, a method for monitoring noise levels of an input signal at a selected frequency is provided. The method includes mixing the input signal to produce a down converted signal at the selected frequency, decimating the down converted signal and computing a value based on the decimated signal. The method further includes comparing the value with a threshold, and monitoring the comparisons to provide time domain analysis of the signal.

### BRIEF DESCRIPTION OF THE DRAWINGS

FIG. 1 is a block diagram of one embodiment of a system comprising a spectrum analyzer according to the teachings of the present invention.

FIG. 2 is a flow chart of one embodiment of a process of spectrum analysis of a signal according to the teachings of the present invention.

FIG. 3 is a block diagram of one embodiment of an adjustable decimation circuit according to the teachings of the present invention.

FIG. 4 is a block diagram of one embodiment of a digital down conversion circuit comprising a spectrum analyzer according to the teachings of the present invention.

FIG. 5 is a block diagram of another embodiment of a system including a time domain analyzer according to the teachings of the present invention.

FIG. 6 is a block diagram of another embodiment of a system with a signal analyzer according to the teachings of the present invention.

FIG. 7 is a screen shot of a sample output of a spectrum analyzer according to the teachings of the present invention.

FIG. 8 is a block diagram of another embodiment of a digital down converter circuit including a signal analyzer according to the teachings of the present invention.

FIG. 9 is a block diagram of an embodiment of a signal analyzer channel for the digital down converter of FIG. 8.

FIG. 10 is a block diagram of an embodiment of an oscillator for the signal analyzer channel of FIG. 9.

FIG. 11 is a block diagram of an embodiment of a mixer for the signal analyzer channel of FIG. 9.

FIG. 12 is a block diagram of an embodiment of a decimator for the signal analyzer channel of FIG. 9.

FIG. 13 is a block diagram of an embodiment of another decimator for the signal analyzer channel of FIG. 9.

FIG. 14 is a block diagram of an embodiment of another decimator for the signal analyzer channel of FIG. 9.

FIG. 15 is a block diagram of an embodiment of a filter for the signal analyzer channel of FIG. 9.

FIG. 16 is a block diagram of an embodiment of a decoder for the signal analyzer channel of FIG. 9.

FIGS. 17 and 18 are block diagrams of an embodiment of a spectrum analyzer for the signal analyzer channel of FIG. 9.

FIG. 19 is a block diagram of an embodiment of a memory controller for the signal analyzer channel of FIG. 9.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide spectrum analysis of signals within a system or on a chip used in transporting data. Essentially an input signal is processed and the power at selected frequencies of the input signal is measured. Integrating the spectrum analysis function enables quick reaction to changes in noise on a communication medium to reduce negative impacts on the transport of data over the medium. Embodiments of the present invention enable the observation of an actual signal from an analog to digital converter within the system. Embodiments of the present invention provide a system that collects and stores information about input signals. In addition, embodiments of the system create a readable output of the information gathered. Additionally, embodiments of the present invention implement time domain processing, e.g., a noise counter.

### I. First Embodiment

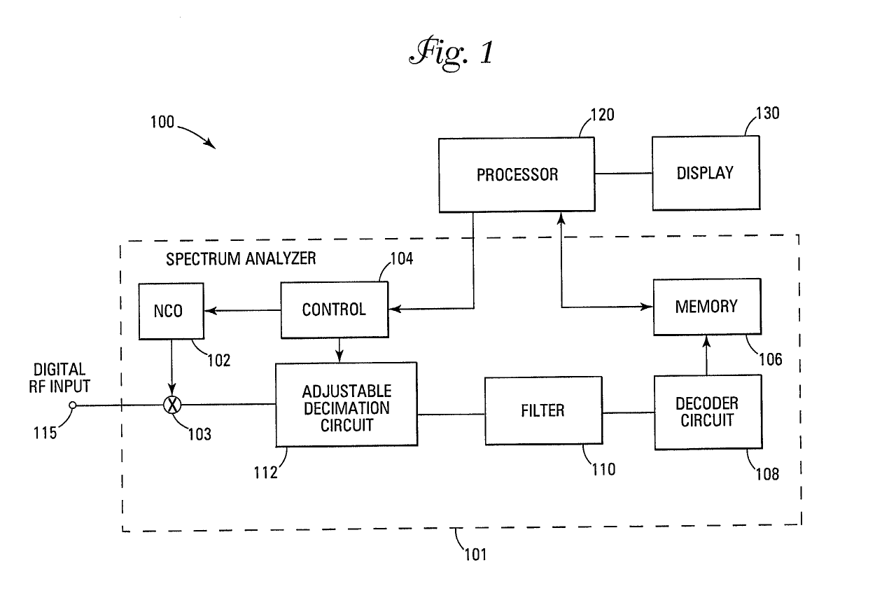

FIG. 1 is a block diagram of an embodiment of an analysis system, indicated generally at 100, according to the teachings of the present invention. System 100 includes a digital radio frequency (RF) input 115 designed to receive an input signal. In one embodiment, the input signal is a digitized representation of upstream signals from DOCSIS compliant, EURO-DOCSIS compliant or other appropriate cable modems. System 100 selectively measures power levels in the input signal at a plurality of frequencies to advantageously allow a service provider identify portions of the frequency spectrum that should not be used for transport of digital data.

System 100 includes a spectrum analyzer 101 that prepares the input signal for processing. Digital RF input 115 is coupled to a mixer 103 that produces a down converted signal from a received input signal. System 100 includes an adjustable decimation circuit 112 that is coupled to mixer 103. The adjustable decimation circuit 112 selectively decimates the down converted signal based, in part, on the source of the input signal and the frequency band used by the input signal. Once the down converted signal has been selectively decimated, it is filtered by filter 110. In one embodiment, filter 110 is a low pass filter. In another embodiment, filter 110 is a finite impulse response low pass filter. Once the signal is filtered, decoder circuit 108 receives it and the power in the signal is measured. In one embodiment, values related to the measured power of the signal are stored in memory 106 with an indication of the associated frequency for the power measurement.

System 100 steps through a selected frequency range in analyzing the spectrum of the input signal. System 100 further includes a control circuit 104 coupled to numerically controlled oscillator (NCO) 102. NCO 102 drives the operation of mixer 103. Control circuit 104 selectively controls the frequency of the down converted signals from mixer 103 through controlling NCO 102. Control circuit 104 establishes an initial control value, a number of steps and a step size for the control value provided to NCO 102. Control circuit 104 steps the NCO 102 through a plurality of frequencies of the frequency spectrum of the input signal, thereby allowing measurement of power over a selected frequency spectrum. In one embodiment, memory 106 is coupled to a processor 120. In one embodiment, processor 120 is integrated with spectrum analyzer 101. In another embodiment, processor 120 is external to spectrum analyzer 101. In one embodiment, spectrum analyzer 101 includes a processor bus where processor 120 reads and writes any registers of spectrum analyzer 101 in order to produce a desired output. In one embodiment, the output of processor 120 is a graph of power levels. In one embodiment, system 100 includes a display 130 coupled to processor 120 that displays the desired output such as a graph of the system power levels.

In operation, system 100 processes digital RF signals for spectrum analysis. A digital RF signal is received at input 115. The digital RF signal is then mixed with an output of NCO 102 by mixer 103 to produce a down converted signal. NCO 102 receives inputs from control circuit 104. Control circuit 104 enables NCO 102 to step through the frequency band of the input signal. This allows the decoder circuit 108 to measure the power of the signal as NCO 102 steps through the frequency band of the signal. The down converted signal is received by adjustable decimation circuit 112 and selectively decimated. For example, in one embodiment, the down converted signal is 200 megasamples/second and the signal is selectively decimated to 20 megasamples/second. The decimated signal is then filtered by filter 110 to remove any undesirable signals or signal components. Decoder circuit 108 then receives the output of filter 110 and measures the power of the output signal. Basically the output of decoder circuit 108 is a power level at a particular frequency. In one embodiment, decoder circuit 108 includes a log function that calculates a log of the measured power. In one embodiment, the output of decoder circuit 108 is a log function of the power. Software controls the measurement and calculation of power by decoder circuit 108. For example, in one embodiment, decoder circuit 108 uses the following equation to calculate the power of the signal at a desired frequency:

Power=\sqrt{I²+Q²}

The I and Q components each have a certain magnitude. The output of the decoder circuit 108 is power at a particular frequency and is input into memory 106. In one embodiment memory 106 is random access memory or the like. The related power information of the filtered signal is stored in memory 106 for processing by processor 120.

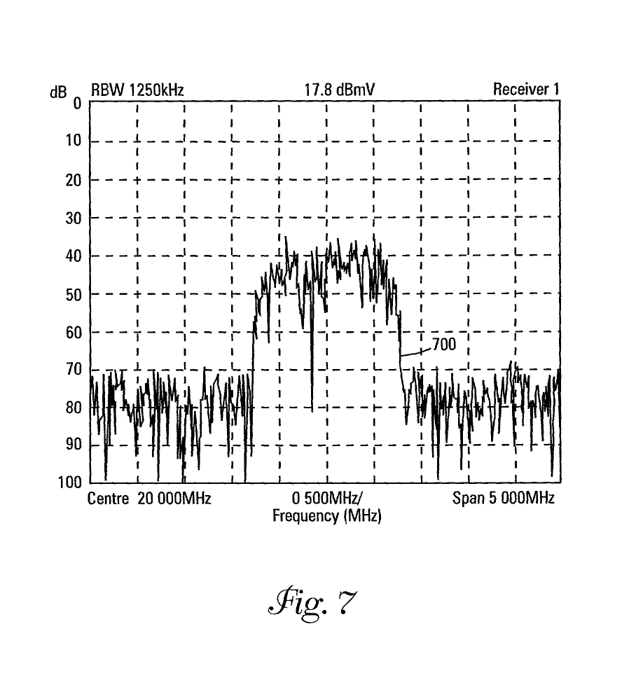

Processor 120 retrieves the power information stored in memory 106 for manipulation and output. In one embodiment the information is further output to display 130 for review by system operators. An example of the type of output provided by processor 120 is shown in FIG. 7. This output provides trace 700 that plots frequency versus power. In one embodiment, the output is a graph of the system power levels.

Processor 120 is also coupled to control circuit 104 and provides control information for control circuit 104 to control NCO 102 and adjustable decimation circuit 112. For example, in one embodiment, processor 120 is used to provide control circuit 104 with the initial frequency, step size and number of steps for NCO 102.

In another embodiment, spectrum analyzer 101 operates in a “zero span mode.” This means that control circuit 104 provides a control signal to NCO 102 that selects a single frequency, band or channel to be monitored. Thus, control circuit 104, in this mode, does not step NCO 102 through a plurality of frequencies. Rather, spectrum analyzer 101 provides time domain analysis of a single frequency band or channel. In this embodiment, the time domain analysis allows spectrum analyzer 101 to see the effect of impulse noise on the selected channel of the communication medium.

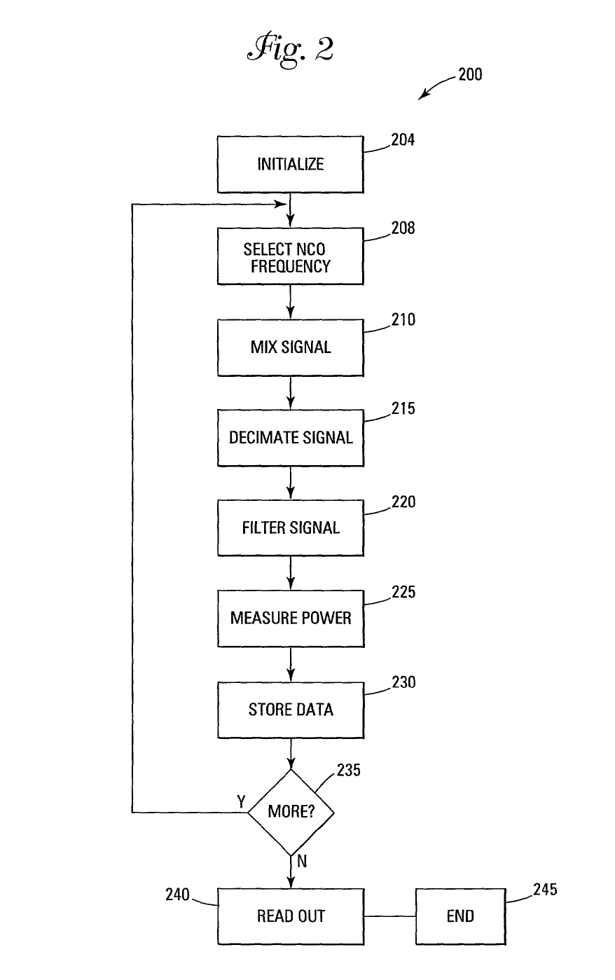

FIG. 2 is a flow chart that illustrates one embodiment of a process, shown generally at 200, for measuring the power of an input signal over a selected frequency spectrum according to the teachings of the present invention. The method begins at block 204 where the system is initialized by the receipt of an input signal. Further, various variables are also initialized. For example, a level of decimation is selected for an adjustable decimation circuit such as adjustable decimation circuit 112 of FIG. 1. Further, in one embodiment, an initial frequency, step size and number of steps for a numerically controlled oscillator used to down convert signals is also established at block 208. In one embodiment, the input signal is a digitized representation of upstream signals from DOCSIS compliant, EURO-DOCSIS compliant or other appropriate cable modems. The method proceeds to block 210 and the signal is mixed to produce a down converted signal at a selected frequency. At block 215 the down converted signal is decimated based, in part, on the bandwidth of the input signal and the desired bandwidth of the output signal. At block 220 the decimated signal is filtered to remove any undesirable signals or signal components. The method proceeds to block 225 and the power level of the decimated signal is measured at the selected frequency. At block 230, data related to the measured power level is stored in a memory such as random access memory. At block 235 the method determines if there are any additional frequencies to be processed. If yes, then the method proceeds to block 208 and the process for measuring power over a selected frequency is repeated. If there are no additional frequencies to be processed the method proceeds to block 240 and the data is read out and displayed. The method proceeds to block 245 and ends.

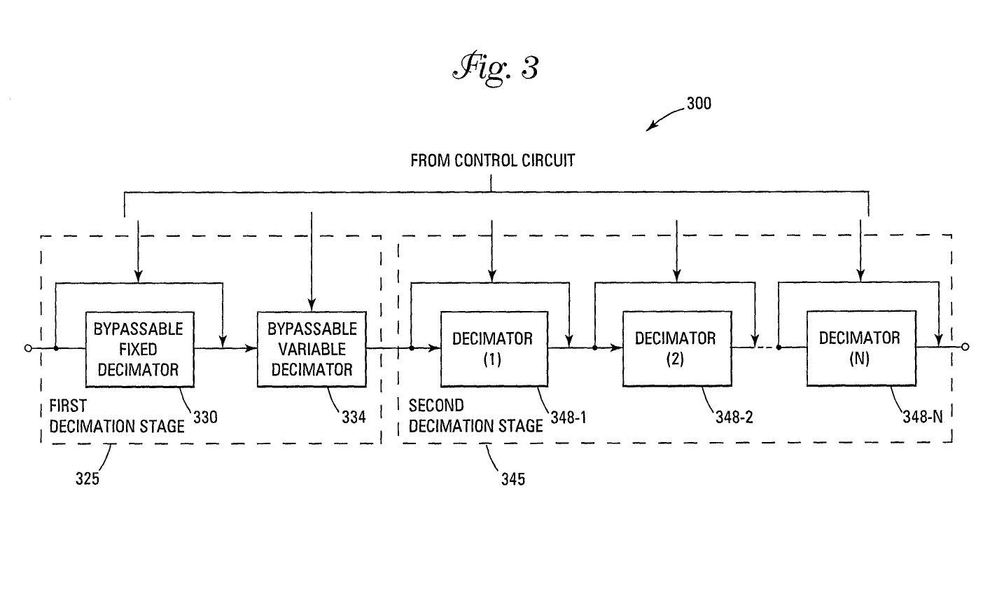

FIG. 3 is a block diagram of one embodiment of an adjustable decimation circuit, indicated generally at 300, according to the teachings of the present invention. Adjustable decimation circuit 300 is used, for example, as adjustable decimation circuit 112 of FIG. 1. Adjustable decimation circuit 300 includes a first and a second decimation stage, 325 and 345, respectively. First decimation stage 325 includes a bypassable fixed decimator 330 coupled to a bypassable variable decimator 334. Control signals control the selection or bypass of the fixed decimator 330 and/or variable decimator 334. The output signal of the first decimation stage 325 is input to the second decimation stage 345. Second decimation stage 345 includes a plurality of bypassable fixed decimators 348-1 to 348-N. Control signals control the bypass or selection of one or more of the plurality of bypassable fixed decimators 348-1 to 348-N.

The first decimation stage 325 is responsive to signals from the control circuit. These signals select a decimation factor for the first decimation stage 325. The selected decimation factor is chosen to reduce the samples per second in the input signal to a desired number of samples per second based on a characteristic of the input signal, e.g, one decimation factor is used for DOCSIS signals and a different decimation factor is used for Euro-DOCSIS signals due to differences in bandwidth. The second decimation stage 345 is responsive to signals from the control circuit. In one embodiment, the second decimation stage 345 selectively reduces the bandwidth of the measured signal or increases the frequency resolution of the measurement. Selecting more of the decimators 348-1 to 348-N decreases the resolution bandwidth. In one embodiment, each of the decimators 348-1 to 348-N is a 2 to 1 decimator and each decimator 348-1 to 348-N cuts the sample rate of the received signal in half. As additional decimators 348-1 to 348-N are selected, the sampling rate gets slower and slower.

### II. Second Embodiment

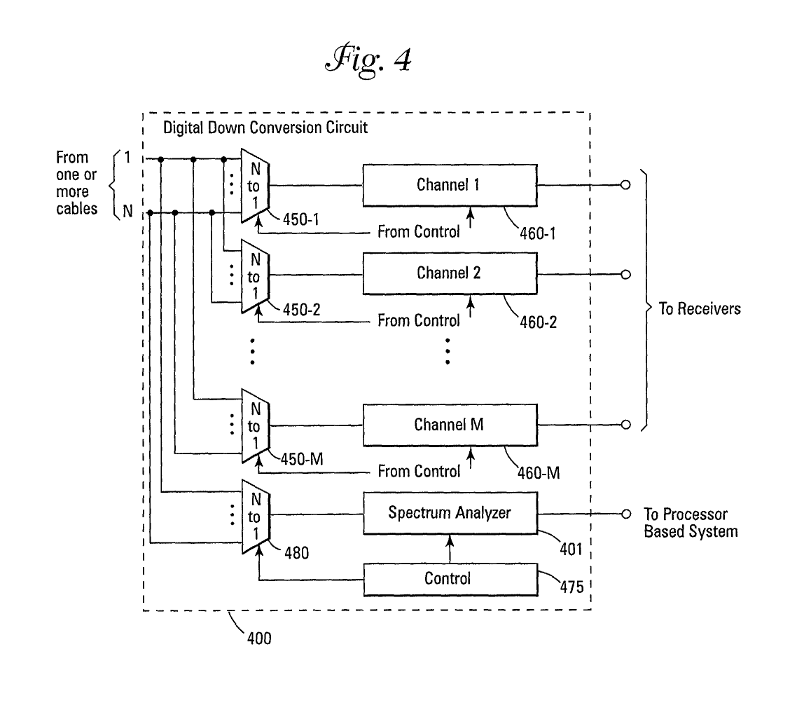

FIG. 4 is a block diagram of one embodiment of a digital down converter, indicated generally at 400, according to the teachings of the present invention. Digital down converter 400 includes a plurality of input ports 1 to N. Digital down converter 400 also includes a plurality of N to 1 multiplexers 450-1 to 450-M. Each N to 1 multiplexer 450-1 to 450-M is coupled to a channel 460-1 to 460-M. In one embodiment, each of channels 460-1 to 460-M comprises a digital down converter circuit of the type described in commonly assigned, co-pending application no. ______ (attorney docket No. 100.225US01) entitled “Digital Down Converter” and filed on even date herewith. In other embodiments, other appropriate digital down converter circuits are used. Each channel 460-1 to 460-M is coupled to a receiver.

Channels 460-1 to 460-M each down convert a selectable channel from a selected one of the input ports 1 to N under the control of control circuit 475. Control circuit 475 includes a control signal applied to each of the multiplexers 450-1 to 450-M. Further, control circuit 475 also provides appropriate control signals to channels 460-1 to 460-M.

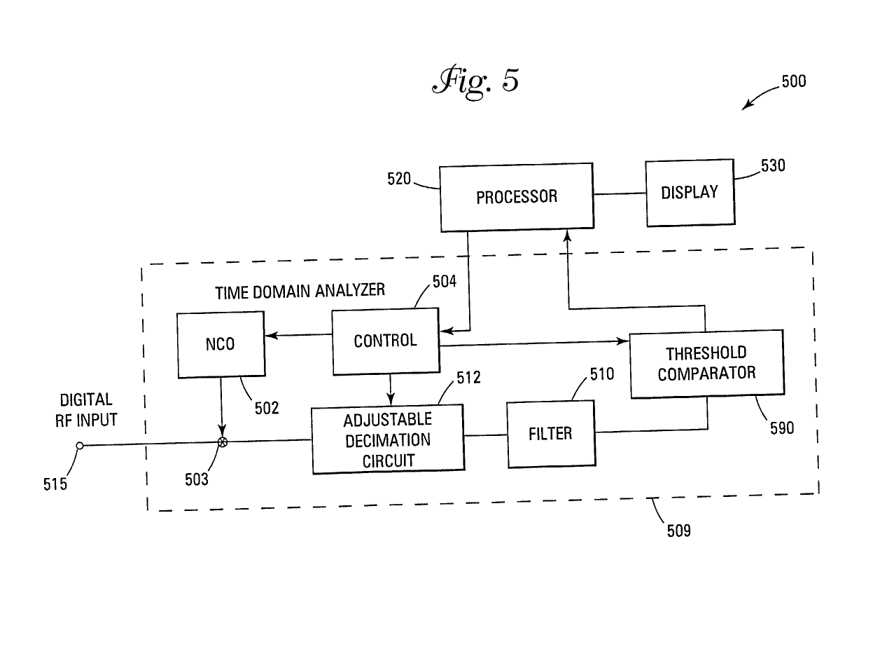

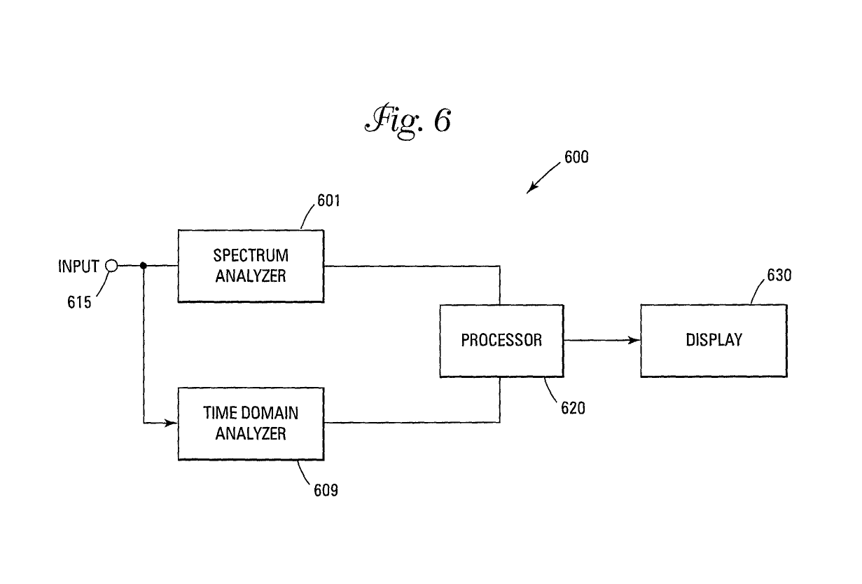

In this embodiment, the outputs of down conversion channels 460-1 to 460-M are coupled to one or more of a plurality of receivers. Digital down conversion circuit 400 includes an additional N to 1 multiplexer 480 selectively coupled to inputs 1 to N. An output of multiplexer 480 is coupled to a spectrum analyzer 401. In one embodiment, spectrum analyzer 401 is a spectrum analyzer as described with respect to FIG. 1 and measures the power of input signals from a selected one of input ports 1 to N over a selected frequency spectrum. In other embodiments, spectrum analyzer 401 comprises a time domain analyzer as shown and described with respect to FIG. 5. In another embodiment, spectrum analyzer 401 comprises a signal analyzer as shown and described below with respect to FIG. 6.

In operation, input signals received over one or more cables at input ports 1 to N are selectively applied to channels 460-1 to 460-M for downcoversion. Each N to 1 multiplexer 450-1 to 450-M selects an input signal from one of the input ports 1 to N under control of control circuit 475. Each channel 460-1 to 460-N then selects one frequency in the upstream band to down convert for the receiver. For example, in one embodiment, a single fiber node is received at one of input ports 1 to N and each channel 460-1 to 460-M tunes to a selected portion of the upstream frequency spectrum. In another embodiment, one cable from a distinct fiber node is coupled to each port 1 to N. In this embodiment, each channel 460-1 to 460-M is tuned to a selected channel on any one of the cables. In another embodiment, any combination of single fiber node cables are couple to input ports 1 to N with each channel tuned to a selected portion of the frequency spectrum on any one of the cables.

In one embodiment, while the plurality of down conversion channels 460-1 to 460-M are busy processing the plurality of inputs 1 to N, the spectrum analyzer 401 is analyzing the inputs and creating a graph of power available in each frequency band on the inputs so that a cable operator can scan for noise sources or open channels without disturbing the processing of the plurality of down conversion channels 460-1 to 460-M.

### III. Third Embodiment

FIG. 5 is a block diagram of one embodiment of a signal analysis system, indicated generally at 500, according to the teachings of the present invention. System 500 includes a digital radio frequency (RF) input 515 designed to receive an input signal. In one embodiment, the input signal is a digitized representation of upstream signals from DOCSIS compliant, EURO-DOCSIS compliant or other appropriate cable modems. System 500 selectively enables estimation of the effect of noise on a channel. In one embodiment, system 500 allows a service provider to examine noise in channels that are not being used to determine if they are usable.

System 500 includes a time domain analyzer 509 that prepares the input signal for processing. Digital RF input 515 is coupled to a mixer 503 that produces a down converted signal from a received input signal. System 500 includes an adjustable decimation circuit 512 that is coupled to mixer 503. The adjustable decimation circuit 512 selectively decimates the down converted signal based, in part, on the source of the input signal and the bandwidth used by the input signal. Once the down converted signal has been selectively decimated, it is filtered by filter 510. In one embodiment, filter 510 is a low pass filter. In another embodiment, filter 510 is a finite impulse response low pass filter. In one embodiment, filter 510 shapes the channel that is being measured. Once the signal is filtered, threshold comparator 590 compares the output of filter 510 with a threshold value selected by control circuit 504. For example, in one embodiment, threshold comparator 590 receives the signal from filter 510 and determines a value for comparison with the threshold based on the following equation:

Value =|I|+|Q|

Threshold comparator 590 has a threshold that is controlled by control circuit 504. This threshold is established based on factors such as the type of modulation to be used to carry signals over the monitored frequency band or channel, expected power levels, and the like. For example, in one embodiment, the threshold is established based on one half of the distance between adjacent points in a constellation for a selected modulation and expected power level.

System 500 compares the output of filter 510 with the threshold over successive time intervals. In one embodiment, these intervals are selected to be the duration of a symbol period for the expected modulation.

System 500 further includes a control circuit 504 coupled to numerically controlled oscillator (NCO) 502. NCO 502 drives the operation of mixer 503. Control circuit 504 selectively controls the frequency of the down converted signals from mixer 503 through controlling NCO 502 to select the un-used channel to be monitored.

In one embodiment, processor 520 is integrated with time domain analyzer 509. In another embodiment, processor 520 is external to time domain analyzer 509. In one embodiment, the output of processor 520 is a noise signal. In one embodiment, system 500 includes a display 530 coupled to processor 520 that displays the desired output such as a noise signal. In another embodiment, the display 550 provides a graphical representation of the noise in the monitored channel.

In one embodiment, processor 520 estimates the noise level of the monitored signal based on a plurality of comparisons by threshold comparator 590. In this embodiment, threshold comparator 590 includes a memory for recording information about the noise for a plurality of successive symbol periods. Processor 520 reads this information and determines the estimate of the noise level of the channel based on a percentage of the symbol periods that the output of filter 510 exceeded or fell below a set threshold.

In operation, system 500 processes digital RF signals for time domain analysis. A digital RF signal is received at input 515. The digital RF signal is then mixed with an output of NCO 502 by mixer 503 to produce a down converted signal. NCO 502 receives inputs from control circuit 504. Control circuit 504 enables NCO 102 to select a channel or frequency band of interest. This allows the threshold comparator to measure the value of the I and Q components of the input signal within a symbol period. The down converted signal is received by adjustable decimation circuit 512 and selectively decimated. The decimated signal is then filtered by filter 510 to remove any undesirable signals or signal components. Threshold comparator 590 then receives the output of filter 510 and compares the signal over a time period, e.g., a symbol period, with a threshold level.

The output of threshold comparator 590 is an estimate or measurement of the noise at a particular time, e.g., within a symbol period, and is provided to processor 520. In one embodiment, the output of comparator 590 is stored in a memory for processing by processor 520.

### IV. Fourth Embodiment

FIG. 6 is a block diagram of an embodiment of a signal analyzer, indicated generally at 600, according to the teachings of the present invention. Signal analyzer 600 includes a digital radio frequency (RF) input 615 designed to receive an input signal. In one embodiment, the input signal is a digitized representation of upstream signals from DOCSIS compliant, EURO-DOCSIS compliant or other appropriate cable modems.

Signal analyzer 600 provides a combination of mechanisms that allow selective monitoring of signals received at input 615. Signal analyzer 600 includes spectrum analyzer 601 that is coupled to receive the input signal at input 615. Spectrum analyzer 601 is constructed, for example, as described above with respect to FIGS. 1, 2, 3, and 7. Spectrum analyzer 601 is coupled to processor 620. Signal analyzer 600 further includes time domain analyzer 609. Time domain analyzer 609 is coupled to spectrum input 615 and is constructed, for example, as described above with respect to FIG. 5. Time domain analyzer 609 is also coupled to processor 620. Processor 620 is coupled to display 630. In one embodiment, spectrum analyzer 601 and time domain analyzer 609 share common components such as a numerically controlled oscillator, a decimation circuit, and a filter.

Processor 620 selectively controls the operation of signal analyzer 600 to select the appropriate signal analysis to be performed. For example, processor 620 provides necessary control signals to spectrum analyzer 601 when frequency spectrum analysis is needed. Further, processor 620 provides control signals to time domain analyzer 609 when time domain analysis is to be performed.

### V. Fifth Embodiment

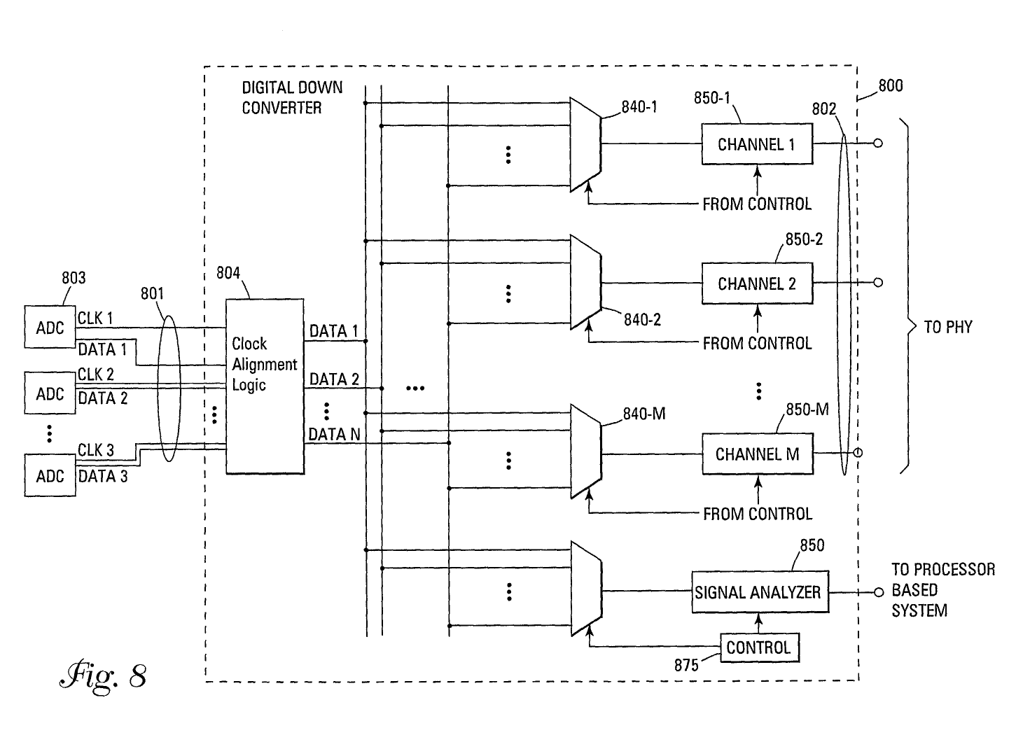

FIG. 8 is a block diagram of another embodiment of a digital down converter circuit, indicated generally at 800, including a signal analyzer 860 according to the teachings of the present invention. Digital down converter 800, in one embodiment, is formed as an Application Specific Integrated Circuit (ASIC) that can receive up to six RF connections at 5-65 MHz at N inputs 801. Digital down converter 800 down converts up to six channels of upstream data from the inputs 801. The received channels are presented to a PHY, e.g., the BCM 3137 Universal Burst Receiver commercially available from Broadcom Corporation of Irvine, Calif., as intermediate frequency signals centered at 5.12 MHz at output 802. Digital down converter 800 accepts input data streams at up to 204.8 Megasamples per second, using parallel inputs at 102.4 MHz. Further, the embodiment provides output samples to the PHY at 40.96 Megasamples per second. Digital down converter 800 also includes signal analyzer 860. Signal analyzer 860 is connected to inputs 801 to selectively process signals from any one of the input data streams. Signal analyzer 860 provides at least one of frequency domain analysis and time domain analysis of the provided signals.

Digital down converter 800 can receive samples from up to six analog-to-digital converters (ADC) 803. Each ADC 803 can provide its own sample clock to the digital down converter 800, but the six clocks must be synchronized to within 5 nanoseconds (ns) of each other. The clock labeled CLK1 in FIG. 8 is used as a master clock and is doubled in an on-chip phase lock loop (PLL) and then divided down to the 40.96 Hz output clock. Digital down converter 800 uses a variable clock divider to privide input flexibility. The clock divider is controlled using the DIV[1:0] pins, as shown in Table 1.

TABLE 1
Input Frequencies

| | | | | | Input |
|---|---|---|---|---|---|
| | | Input | Output | | Bandwidth |
| | Clock | Clock | Clock | Input Bandwidth | (1 sample/ |
| DIV[1:0] | Divisor | (MHz) | (MHz) | (2 samples/cycle) | cycle) |
| 0 | 1 | 40.96 | 40.96 | 5-40 MHz | 5-20 MHz |
| 1 | 2 | 81.92 | 40.96 | 5-81 MHz | 5-40 MHz |
| 2 | 2.5 | 102.4 | 40.96 | 5-102 MHz | 5-51 MHz |
| 3 | 3 | 122.88 | 40.96 | 5-122 MHz | 5-61 MHz |

The input samples are received by a crossbar illustrated as multiplexers 840-1 to 840-M, which can connect any input signal 801 to any digital down converter channel 850-1 to 850-M or to the signal analyzer 860. A single input stream may be directed to multiple channels, allowing several upstream frequencies to be selected from a single input. The outputs from ADCs 803 may be up to twelve bits wide. Each input port has an A and a B sample input. ADCs 803 that provide two samples per cycle connect to both the A and the B inputs, and the B input should be the later sample than the A input. ADCs 803 that provide a single sample per cycle, are connected to just the A inputs.

The inputs 801 are received through clock alignment logic 804. Clock alignment logic 804 brings the six individual clock domains into a single core clock domain. The clock alignment logic 804 also has control bits that can convert the data from unsigned to two's complement, swap the A and B ports, or swap the input busses from most significant bit to least significant bit for ADCs 803 with pinouts that make the module wiring difficult in the default order. The clock alignment block 804 can accept inputs from ADCs 803 in either parallel or interleaved format.

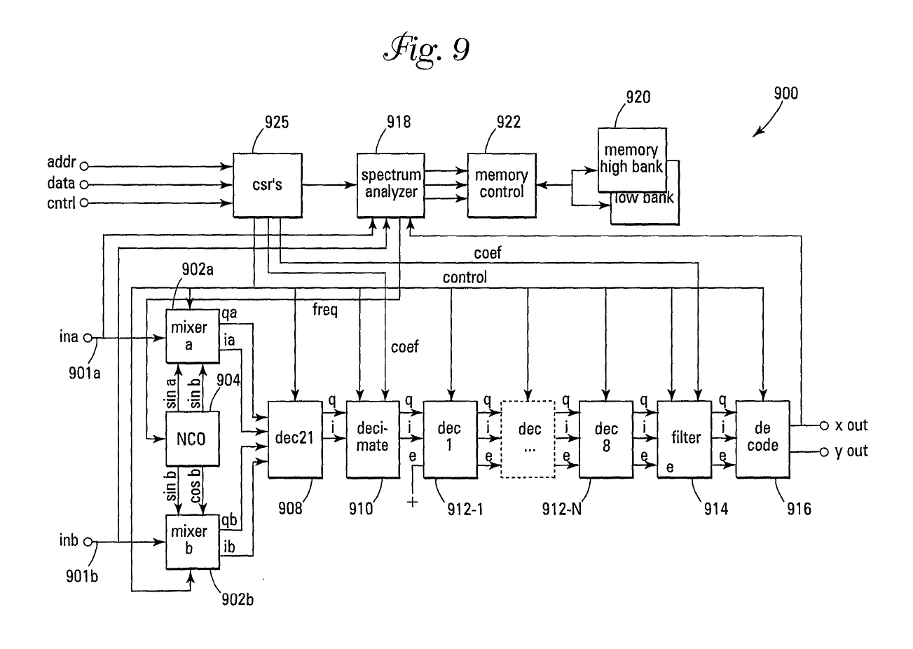

FIG. 9 is a block diagram of an embodiment of a signal analyzer channel, indicated generally at 900, for the digital down converter of FIG. 8. The signal analyzer channel 900 has some additional logic compared to digital down converter channels 850-1 to 850-M to make it a spectrum analyzer.

Channel 900 receives an input signal at inputs 901a and 901b. Advantageously, channel 900 is designed to accept signals at inputs 901a and 901b that comply with a number of standards, including but not limited to, the DOCSIS standard, the Euro-DOCSIS standard and other appropriate standards for providing data over a cable network.

Signal analyzer channel 900 down converts the input stream at inputs 901a and 901b under the control of channel control and state register (CSR) 925. Signal analyzer channel 900 converts the input stream to baseband using a numerically controlled oscillator (NCO) 904 and mixers 902a and 902b. In one embodiment, NCO 904 is tunable from −65 to 65 MHz. The down converted data is then sent through a series of decimating filters 908 and 910. In one embodiment, the output of decimating filters 908 and 910 is “I” and “Q” sample streams at 20.48 megasamples per second.

In one embodiment, signal analyzer channel 900 also has a plurality of two-to-one decimators 912-1 to 912-N. Decimators 912-1 to 912-N can be individually enabled or disabled, changing the sample frequency (and bandwidth) of filter 914. In one embodiment, channel 900 includes 8 two-to-one decimators. In one embodiment, filter 914 comprises a low-pass 53 tap FIR filter with programmable coefficients.

Signal analyzer 900 also includes decoder 916 that processes the output of filter 914 either in the frequency domain or in the time domain. In one embodiment, decoder 916 calculates logarithmic power and output voltage. Decoder 916 provides this data to spectrum analyzer 918. Spectrum analyzer 918, in one embodiment, is loaded with start-frequency, frequency step-size and number of steps for a spectrum analysis. Spectrum analyzer provides this information to numerically controlled oscillator 904 to control the gathering of data. The output of spectrum analyzer 918, in one embodiment, is stored in memory banks 920 under the control of memory control 922.

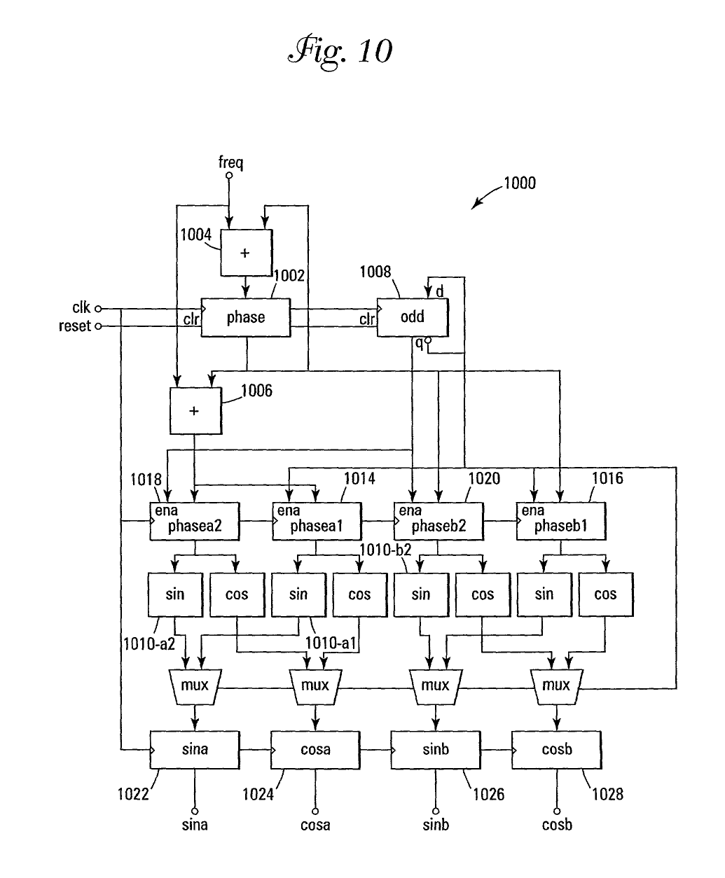

FIG. 10 is a block diagram of an embodiment of an oscillator, indicated generally at 1000, for the signal analyzer channel of FIG. 9. For example, oscillator 1000 is operable to provide appropriate output signals to drive mixers 902a and 902b.

Oscillator 1000 is a numerically controlled oscillator, and produces both sine and cosine functions for both the A and B channels. Every clock cycle of clock signal CLK, the input frequency word (freq) is added to the phase accumulator 1002 at summer 1004. The frequency word divided by two is added to the output of the phase accumulator 1002 at summer 1006 to compute the phase for the odd, or A, samples. The frequency word is a signed quantity, allowing the oscillator to spin in the opposite direction, effectively swapping sine and cosine or the “Q” and “I” channels.

Oscillator 1000 includes a plurality of sine generators 1010-a2, 1010-a1, 1010-b2, and 1010-b1 and cosine generators 1012-a2, 1012-a1, 1012-b2, and 1012-bl. In one embodiment, the speed of the combinatorial sine generators and cosine generators are not high enough to run at the input clock rate CLK. To allow the logic to run at speed, two complete sets of sine generators and cosine generators are used as shown, running one clock cycle out of phase. The flip-flop odd 1008 divides the input clock by two, and is used to alternately load the registers 1014 and 1016, respectively, and registers, 1018 and 1020, respectively, and simultaneously select between the sine generators and cosine generators, to load the output registers 1022, 1024, 1026, and 1028, respectively.

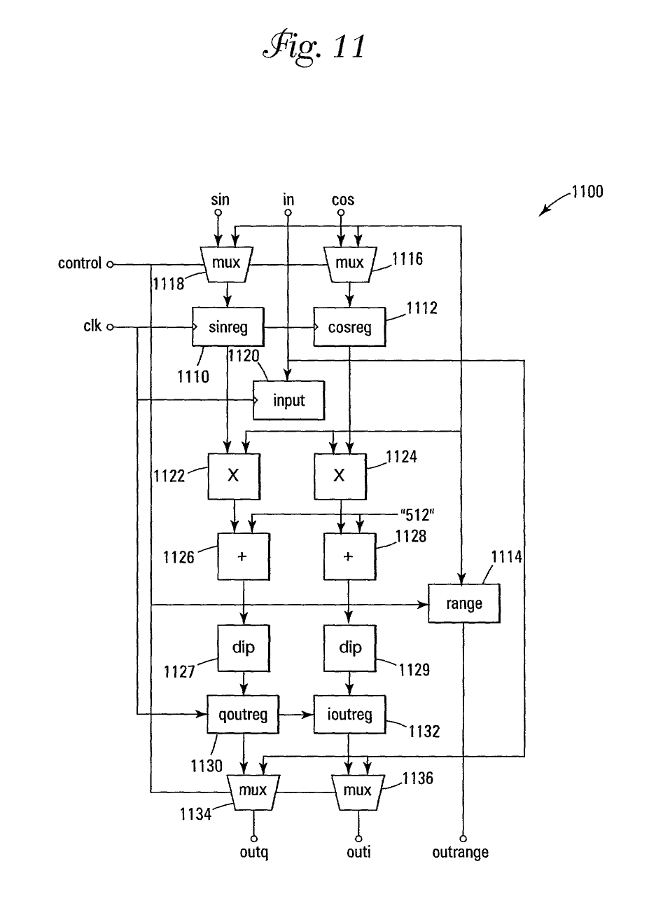

FIG. 11 is a block diagram of an embodiment of a mixer, indicated generally at 1100, for the signal analyzer channel of FIG. 9. For example, in one embodiment, mixers 902a and 902b are implemented as shown and described below with respect to FIG. 11.

Mixer 1100 receives and stores an input signal in register 1120 on each clock cycle. The input data is checked by the block range 1114 and an out of range signal is generated when the data is too close to the minimum or maximum signal levels, this threshold is programmable to 25, 12.5, 6.25 or 3.125 percent from the maximum signal range.

Mixer 1100 also receives sine and cosine inputs from an oscillator such as oscillator 1000 of FIG. 10. Mixer 1100 loads the sine and cosine values into registers 1110 and 1112, respectively, on every clock cycle. The multiplexers 1116 and 1118 in front of the sine and cosine registers 1112 and 1110, respectively, are for chip testing, and switch between the sine and cosine inputs or the delayed input signal.

The content of the input register 1120 is multiplied with the content of the sine and cosine registers 1110 and 1112 at multipliers 1122 and 1124, to perform the actual mixer function of producing I and Q values. The ten least significant bits of the product are ignored, after adding 512 to cause proper rounding at adders 1126 and 1128. The result is now clipped to 4096 to 4095, to make sure the output will not wrap at clippers 1127 and 1129. Every clock cycle the truncated and clipped I and Q values are stored into the output registers 1130 and 1132. The multiplexers 1134 and 1136 in the output data path are for chip testing; the input data is gated directly onto the output pins (flow-through mode).

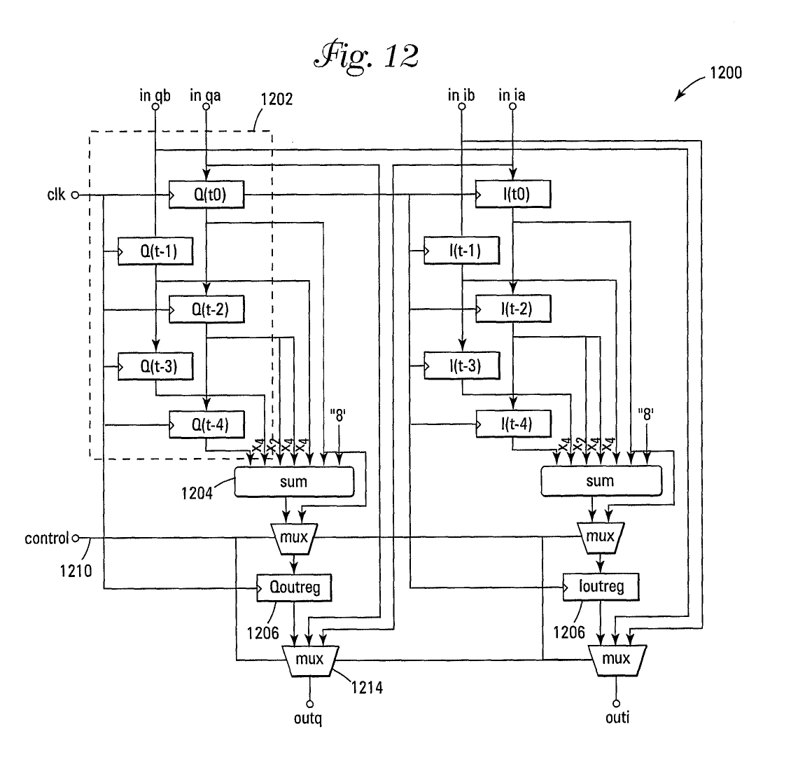

FIG. 12 is a block diagram of an embodiment of a decimator, indicated generally at 1200, for the signal analyzer channel of FIG. 9. In one embodiment, decimator 908 of FIG. 9 is constructed as shown and described below with respect to FIG. 12.

Decimator 1200 comprises a two to one decimator that reduces the four input streams (odd and even samples of both the Q and I streams) into just two steams at half the sample rate (Q and I). Since the I data and the Q data are handled in a similar manner, only the circuitry for handling the Q data is described in detail.

Every clock cycle both the odd and even samples are shifted into a five-sample deep shift register 1202. The five samples are added together with weight factors of 1, 4, 6, 4 and 1 respectively by summer 1204. To guarantee proper rounding, another “eight” is added to the total sum by summer 1204. The four least significant bits are ignored (filter has a gain of 16), and the output is loaded into the output register 1206.

Decimator 1200 is selectably bypassed by control signal 1210 for analog to digital converters that produce just a single stream of samples. Decimator 1200 includes multiplexer 1212 that is controlled by control signal 1210. When decimator 1200 is to be bypassed, control signal 1210 causes the input register to be clocked into the output register unmodified. Multiplexer 1214 is for chip testing; the input data is gated directly onto the output pins (flow-through mode).

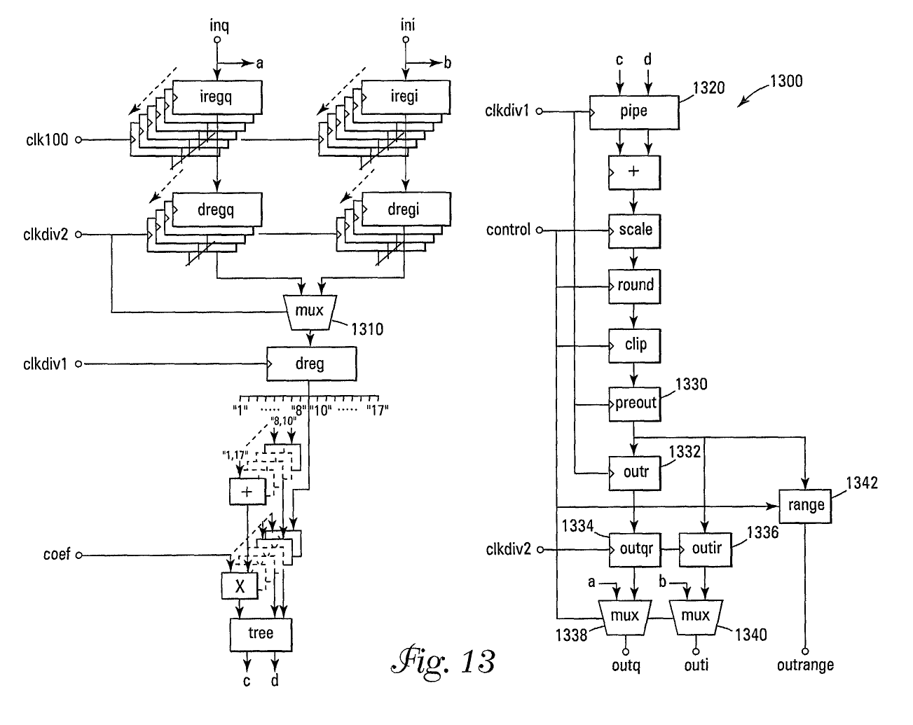

FIG. 13 is a block diagram of an embodiment of another decimator, indicated generally at 1300, for the signal analyzer channel of FIG. 9. In one embodiment, decimator 910 of FIG. 9 is constructed as shown and described with respect to decimator 1300 of FIG. 13.

The decimator 1300 reduces the sample frequency from the “Q” and “I” streams by a factor between 3 and 6. Six samples of the input signals inq and ini are saved in the input shift registers iregq and iregi respectively. Then 3, 4, 5 or 6 samples at a time are shifted through the shift registers dregq and dregi. The clock used is now the input clock divided by the same factor between 3 and 6. A total of 17 samples are kept in these last two shift registers. To reduce the amount of gates, the next section is shared between the “Q” and “I” data streams, and operates at double the clock rate, alternating between “Q” and “I” samples. The content of dregq and dregi is multiplexed by multiplexer 1310 and loaded into the register dreg. The filter operates at 17 samples, and is symmetric; this means that only 9 multiplications have to be performed. The samples 1 and 17, 2 and 16, through 8 and 10 are added first before being multiplied with the filter coefficients. Nine partial multipliers, because of the speed advantage, perform the multiplications. The 18 partial products are added together to form two partial sums, before being loaded into the pipeline register 1320. Before load into register 1330, the data is scaled (multiplied by the fractional portion of the gain), rounded (a number is added to cause proper rounding), and clipped to the bits specified by the power-of-two gain. Registers 1332, 1334, and 1336 are used to de-multiplex the combined “Q” and “I” stream into two separate data streams. Multiplexers 1338 and 1340 are for chip testing; the input data is gated directly onto the output pins (flow-through mode). The block “range” 1342 checks the signal levels, and an out of range signal is generated when the data is too close to the minimum or maximum of the range, the threshold is programmable to 25, 12.5, 6.25 or 3.125 percent.

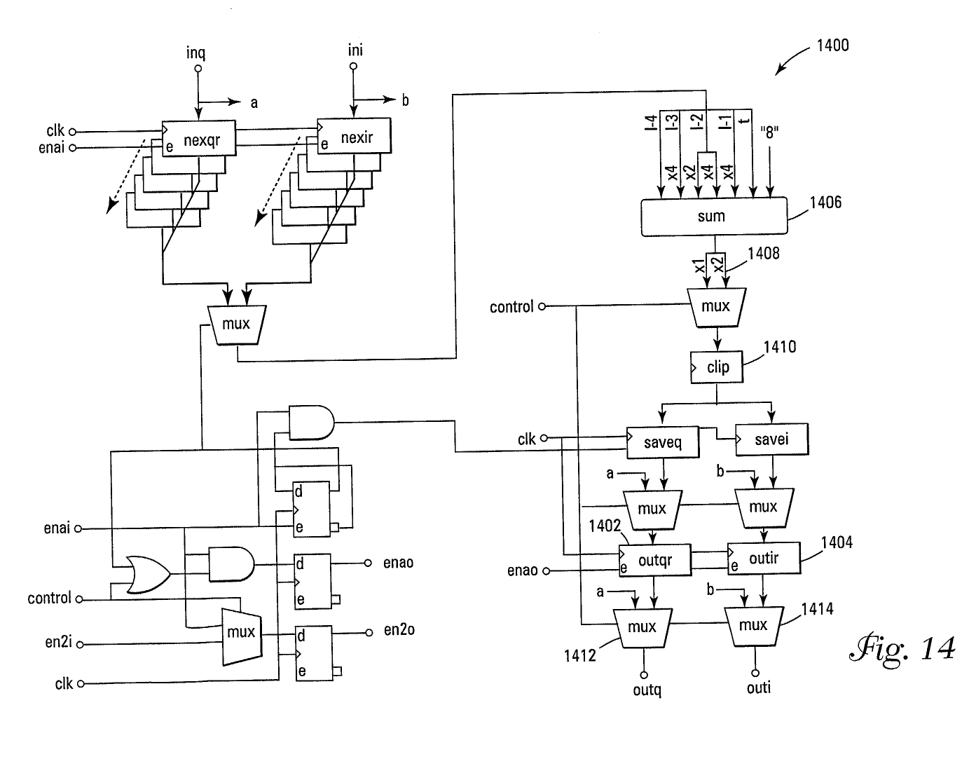

FIG. 14 is a block diagram of an embodiment of another decimator, indicated generally at 1400, for the signal analyzer channel of FIG. 9. In one embodiment, each decimator 912-1 to 912-N is constructed as shown and described with respect to decimator 1400 of FIG. 14.

Decimator 1400 is a two-to-one decimator that is selectively enabled or disabled. When disabled, the Q and I input data is gated directly into output registers 1402 and 1404, together with the input enables. When enabled, decimator 1400 performs the signal decimation. The last five samples of Q and the last six samples of I are saved in the registers nexqr and nexir. For every input sample, the decimation function is applied to the last five samples of either Q or I.

The input samples are added with weight factors of 1, 4, 6, 4 and 1 at summer 1406. The output of summer passes through gain stage 1408 with a gain of 1 or 2. After clipping at clipper 1410, the combined Q and I stream is separated into individual Q and I streams by registers saveq, and savei. The output of the saveq and savei registers are stored in output registers outqr and outir. Multiplexers 1412 and 1414 are for chip testing; the input data is gated directly onto the output pins (flow-through mode).

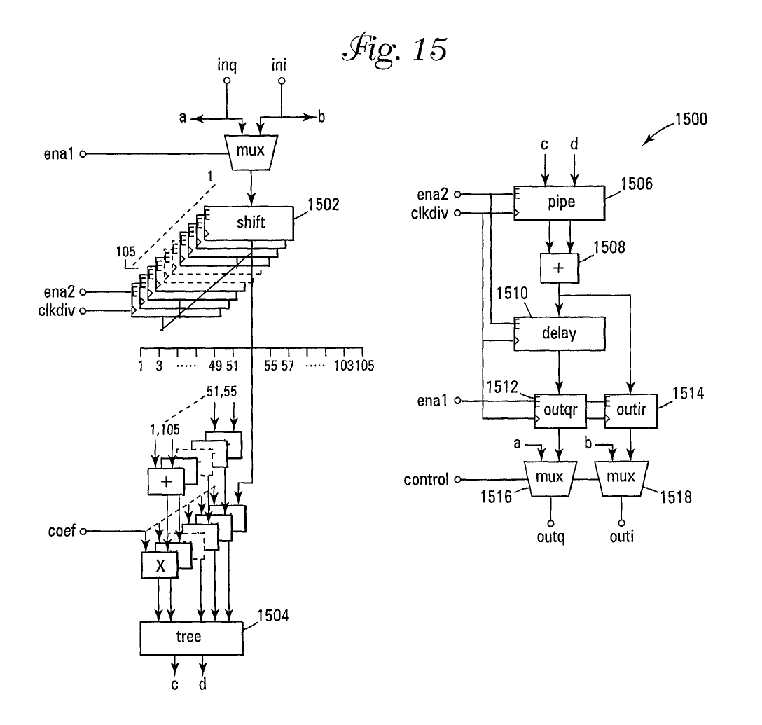

FIG. 15 is a block diagram of an embodiment of a filter, indicated at 1500, for the signal analyzer channel of FIG. 9. In one embodiment, filter 914 of FIG. 9 is constructed as shown and described with respect to filter 1500 of FIG. 15. Filter 1500 is the final band-shaping filter. The filter 1500 is a symmetric 53-tap filter running at 20.48 MHz, the 16 outer tap coefficients are 10 bit signed integers, and the remaining 11 inner coefficients are 12 bits signed numbers. To reduce gate-count, there is only one version of the filter, operating at twice the frequency on alternating “Q” and ‘T’ samples. Every ena1 clock cycle, either inq or ini is shifted into a 105 deep shift register 1502. The filter 1500 operates using all odd samples of the shift register, these are the last 53 samples of either “Q” or “I”. The samples on both sides of the shift register with the same tap coefficients are first added together (26 adders), and then multiplied with its corresponding coefficient. The center tap is multiplied directly with its coefficient. The outputs of the 27 partial multipliers are reduced in a reduction tree 1504 to just two partial sums. After pipeline register 1506 the partial sums are added together at summer 1508. Registers 1510, 1512, and 1514 are for splitting the combined data stream into a separate “Q” and “I” stream. Multiplexers 1516 and 1518 are for chip testing; the input data is gated directly onto the output pins (flow-through mode).

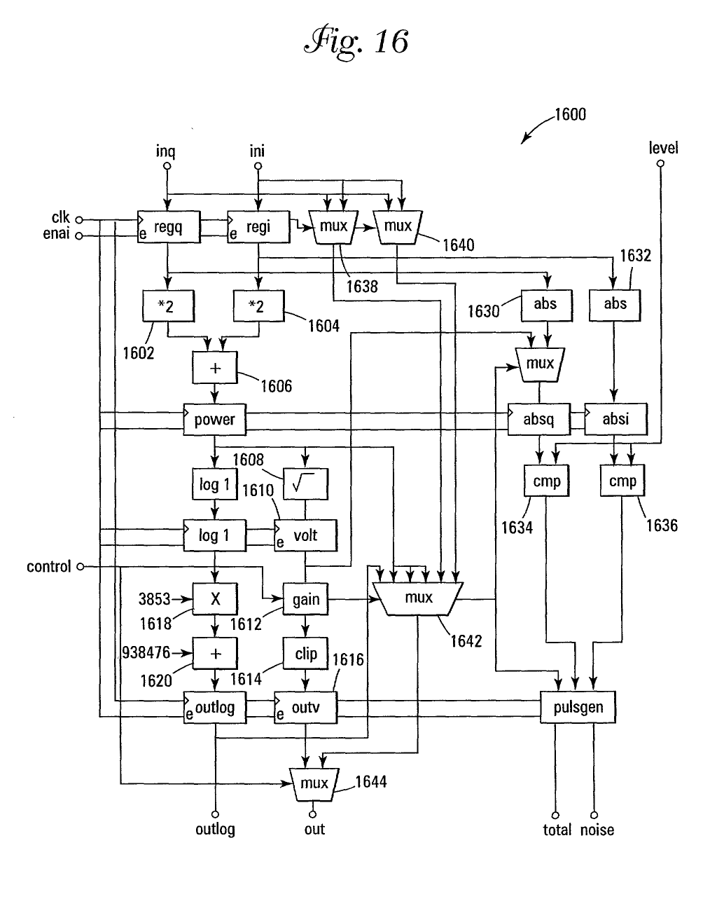

FIG. 16 is a block diagram of an embodiment of a decoder, indicated generally at 1600, for the signal analyzer channel of FIG. 9. In one embodiment, decoder 918 of FIG. 9 is constructed as shown and described with respect to decoder 1600 of FIG. 16.

Decoder 1600 computes the output voltage and logarithmic output power from the output signal from a filter, e.g., filter 914 of FIG. 9. Decoder 1600 receives the output signal and stores it in registers regq and regi. The content of these registers is squared at square functions 1602 and 1604, respectively. The output power is then calculated by summing the content of registers 1602 and 1604 at summer 1606. The power value is stored in register power.

The value in register power is used to selectively calculate output values. In one embodiment, square root function 1608 calculates a square root of the value in register power. This value is stored in register 1610. The output of register 1610 is voltage modified by gain block 1612, clip block 1614, and stored in register 1616.

In another embodiment, a log function is applied to the value stored in register power. The log function is performed in two stages. In the first stage the most significant bit of the power is detected, and the encoded bit number (lsb=0) is loaded into bit 12 through 17 of the register log 1, while the 12 next significant bits are loaded into bits 0 through 11 of the register log 1. In the second stage, the value in register log 1 is multiplied by 3853 at multiplier 1618 and 938476 is added at summer 1620. The first number is 128*100*log(2), while the second number is an offset to minimize the absolute error. The output of this calculation is an approximation of 100*log (power) times 524288 or 2A19. After discarding the 19 least significant bits, the result is loaded into the output register outlog.

In one embodiment, a noise detector is also implemented in decoder 1600. The noise detector first calculates the absolute value of the content of the Q and I input registers at absolute value functions 1630 and 1632, respectively. The absolute values are stored in registers absq and absi and compared the to the specified noise level at comparators 1634 and 1636. Pulses to update the noise counters are then generated based on the output of the comparators 1634 and 1636.

Multiplexers 1638, 1640, 1642 and 1644 are for chip testing; the most or least significant half of the Q or I input data is gated directly onto the output pins (flow-through mode). For testing the decoder itself, the output of the log function, or one of three sets of thirteen bits of the power register is gated onto the decoder output pins.

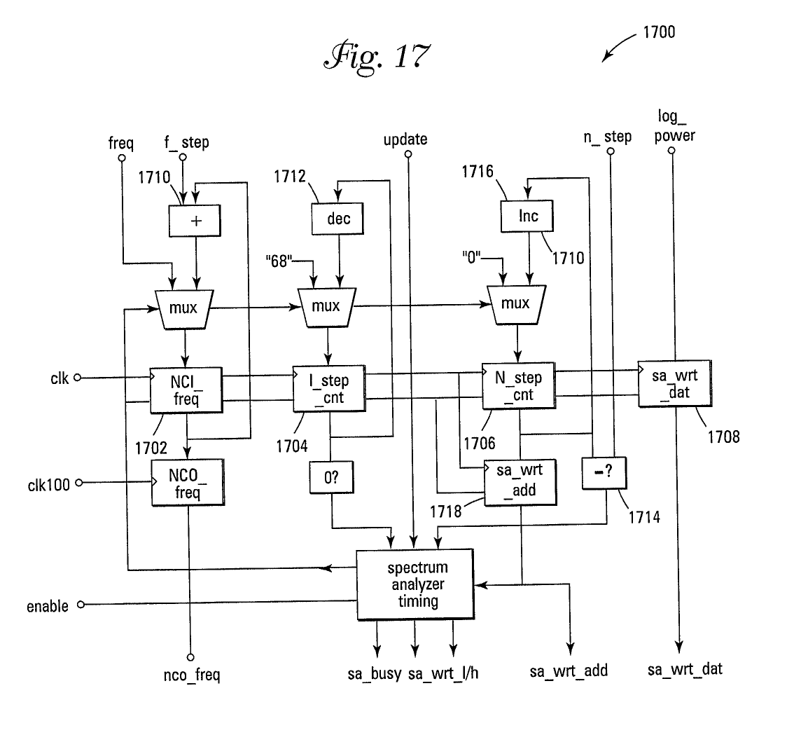

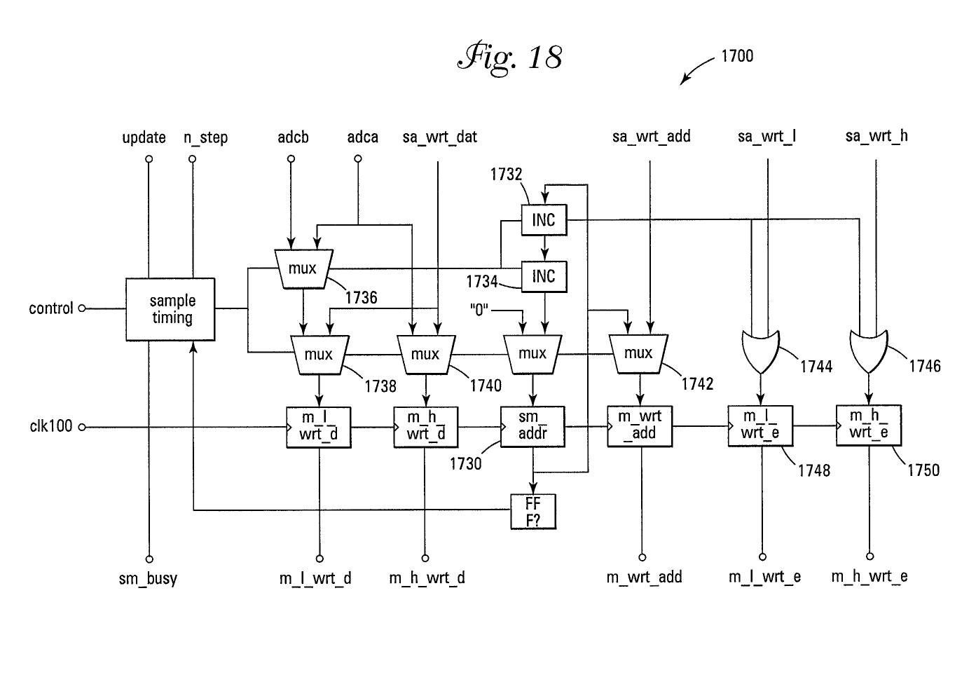

FIGS. 17 and 18 are block diagrams of an embodiment of a spectrum analyzer, indicated generally at 1700 for the signal analyzer channel of FIG. 9. In one embodiment, spectrum analyzer 918 is constructed as shown and described with respect to spectrum analyzer 1700 of FIGS. 17 and 18.

The spectrum analyzer 1700 uses registers 1702, 1704, 1706, and 1708 to control the operation of a numerically controller oscillator, e.g., NCO 904 of FIG. 9, and to control the storage of data in a memory, e.g., storage of log power data from decoder 916 in memory banks 920.

Register 1702 is a frequency accumulator that stores the accumulated frequency as the spectrum analyzer steps an NCO through a frequency range. Registor 1702 stores the output of summer 1710. Summer 1710 adds the content of the f_step register every time spectrum analyzer 1700 changes to the next frequency.

Register 1704 (1_step_cnt) determines the duration of each step for spectrum analyzer 1700. Register 1704 counts through each step. At the beginning of a step, register 1704 is loaded with 68. Decremeter 1712 decrements the value in register 1704 on decimated clock cycles, until the value stored in decrementer 1712 reaches zero. This defines the end of a step.

Register 1706 (N_step_cnt) determines when the selected number of steps has been accomplished. Register 1706 starts out at zero. Register 1706 is incremented at the end of every step at incrementer 1716. The content of register 1706 is compared with the input n step at comparator 1714. When the value in register 1706 reaches parity with the value selected for n_step, the spectrum analyzer 1700 is stopped.

At the end of each step the content of register 1706 is loaded into register 1718 (sa_wrt_add). The value in register 1718 is used as the memory address for the data to be stored. Also at the end of each step the logarithmic power output of the tuner is sampled and stored in register 1708 (sa_wrt_dat) and used as the data for the memory write.

The remaining logic of spectrum analyzer 1700 is shown in FIG. 18. In FIG. 18, this portion of spectrum analyzer 1700 is for sampling raw analog to digital converter data and writing the samples into memory. When register 1706 (n_step_cnt) is loaded with zero's the sampler is started. The sample address register 1730(sm_addr) is loaded with zero, and each cycle the value is incremented. The value in register 1730 is incremented by one of incrementers 1732 and 1734 when a single channel ADC is used, and incremented by both when an ADC is used that produces two samples every clock cycle. In the data path, multiplexers 1736, 1738 and 1740 control the data flow from the two ADC channels, and the data from the spectrum analyzer 1700. There is also a multiplexer 1742 for switching memory addresses from the sampler and the spectrum analyzer. OR-gates 1744 and 1746 and flip-flops 1748 and 1750 generate the write enable signals to the memory controller.

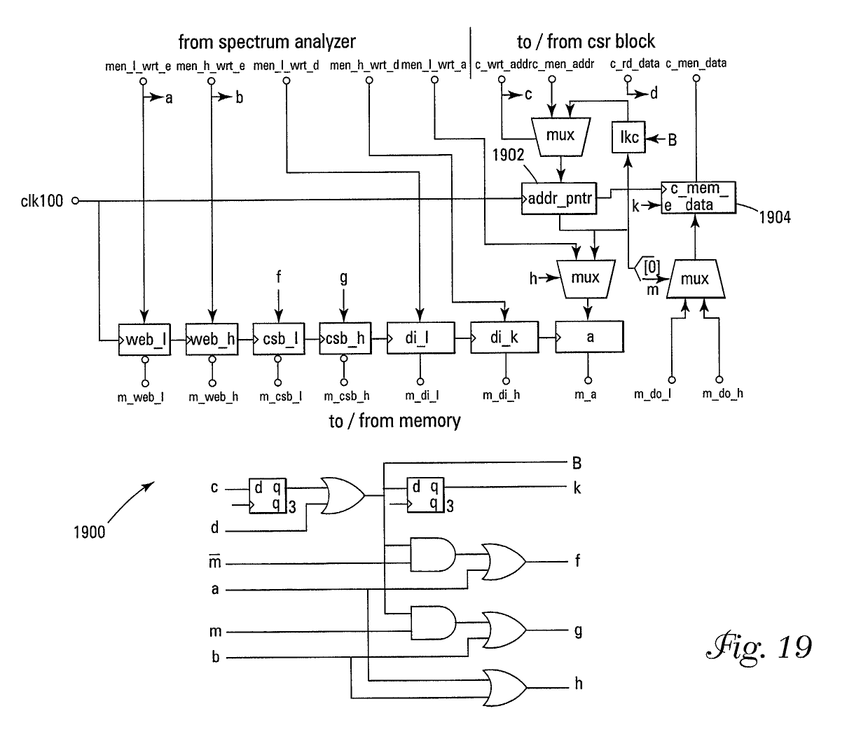

FIG. 19 is a block diagram of an embodiment of a memory controller, indicated generally at 1900, for the signal analyzer channel of FIG. 9. In one embodiment, memory controller 922 of FIG. 9 is constructed as shown and described with respect to memory controller 1900 of FIG. 19.

Memory controller 1900 has an auto-increment register 1902 for memory addresses from the CPU interface. When the address is written, the first memory location is read, its data stored in register 1904 (c_mem_data), and the address pointer in register 1902 is incremented. When the CPU reads the memory data register 1904, the signal c_rd_data performs the same operation, reading the next data-word from memory, and incrementing the address register 1902. The rest of the registers pipeline the remaining signals to the memory banks, chip select (m_csb), write enable (m_web) and data (mdi).

What is claimed is:

1. A spectrum analyzer, comprising:
an input adapted to receive an input signal;
a mixer, coupled to the input, the mixer adapted to produce a down converted signal from the input signal;
an adjustable decimation circuit, coupled to the mixer, that selectively decimates the down converted signal;
a decoder, coupled to the adjustable decimation circuit, that measures power in the decimated signal; and
a control circuit, coupled to the mixer, that selectively controls the frequency of the down converted signals from the mixer to measure power over a frequency spectrum of the input signal.

2. The spectrum analyzer of claim 1, and further including a memory, coupled to the decoder, that stores values related to the measured power.

3. The spectrum analyzer of claim 1, and further including a numerically controlled oscillator, coupled to the mixer and to the control circuit, wherein the control circuit steps the numerically controlled oscillator through a plurality of frequencies.

4. The spectrum analyzer of claim 1, wherein the adjustable decimation circuit includes:
a first stage, responsive to signals from the control circuit, the first stage selectively reducing the sampling rate of the down converted signal based on a characteristic of the input signal; and
a second stage, responsive to signals from the control circuit, the second stage selectively reducing the bandwidth of the down converted signal.

5. The spectrum analyzer of claim 1, wherein the decoder measures the power by calculating a value based on I and Q components of the signal.

6. The spectrum analyzer of claim 5, wherein the decoder calculates the value based on the equation:
Power=\sqrt{I²+Q²}

7. The spectrum analyzer of claim 3, wherein the control circuit establishes an initial control value, a number of steps and a step size for the control value provided to the numerically controlled oscillator.

8. The spectrum analyzer of claim 3, wherein the control circuit establishes a control value to select a frequency band in a zero span mode.

9. The spectrum analyzer of claim 1, wherein the decoder circuit further includes a log function that calculates a log of the measured power.

10. A method for measuring power of an input signal over a selected frequency spectrum, the method comprising:
mixing the input signal to produce a down converted signal at a selected frequency;
decimating the down converted signal;
measuring a power level of the decimated signal; and
repeating the process of mixing, decimating, measuring and storing to produce power measurements at a plurality of frequencies.

11. The method of claim 10, and further including storing the value for each of the measured power levels.

12. The method of claim 11, and further including reading out and displaying the measured power levels.

13. The method of claim 10, wherein mixing the signal comprises mixing the signal under the control of a numerically controlled oscillator.

14. The method of claim 10, wherein measuring the power level comprises calculating a value based on I and Q components of the signal.

15. The method of claim 14, wherein calculating a value comprises calculating a value for the power level based on the equation:
Power=\sqrt{I²+Q²}

16. The method of claim 14, wherein calculating a value based on I and Q components of the signal further comprises calculating a log of the measured power level.

17. A method for measuring power of an input signal at a selected frequency, the method comprising:
mixing the input signal to produce a down converted signal at the selected frequency;
decimating the down converted signal;
repeatedly measuring a power level of the decimated signal; and
monitoring the measured power levels over a period of time.

18. The method of claim 17, and further including storing the value for each of the measured power levels.

19. The method of claim 18, and further including reading out and displaying the measured power levels.

20. The method of claim 17, wherein mixing the signal comprises mixing the signal under the control of a numerically controlled oscillator.

21. The method of claim 17, wherein measuring the power level comprises calculating a value based on I and Q components of the signal.

22. The method of claim 21, wherein calculating a value comprises calculating a value for the power level based on the equation:
Power=\sqrt{I²+Q²}

23. The method of claim 21, wherein calculating a value based on I and Q components of the signal further comprises calculating a log of the measured power level.

24. An analysis system, comprising:
an input adapted to receive an input signal;
a mixer, coupled to the input, the mixer adapted to produce a down converted signal from the input signal;
a numerically controlled oscillator, coupled to the mixer, to provide a signal for down converting the input signal;
an adjustable decimation circuit, coupled to the mixer, that selectively decimates the down converted signal;
a decoder, coupled to the adjustable decimation circuit, that measures power in the decimated signal;
a memory, coupled to the decoder, that stores values related to the measured power; and
a control circuit, coupled to the numerically controlled oscillator and responsive to a processor, that selectively controls the frequency of the down converted signals from the mixer to measure power over a frequency spectrum of the input signal based on values supplied by the processor.

25. The spectrum analyzer of claim 24, wherein the adjustable decimation circuit includes:
a first stage, responsive to signals from the control circuit, the first stage selectively reducing the sampling rate of the down converted signal based on a characteristic of the input signal; and
a second stage, responsive to signals from the control circuit, the second stage selectively reducing the bandwidth of the down converted signal.

26. The spectrum analyzer of claim 24, wherein the decoder measures the power by calculating a value based on I and Q components of the signal.

27. The spectrum analyzer of claim 26, wherein the decoder calculates the value based on the equation:
Power=\sqrt{I²+Q²}

28. The spectrum analyzer of claim 24, wherein the control circuit establishes an initial control value, a number of steps and a step size for the control value provided to the numerically controlled oscillator.

29. The spectrum analyzer of claim 24, wherein the decoder circuit further includes a log function that calculates a log of the measured power.

30. A digital down conversion circuit with a spectrum analyzer, the circuit comprising:
a plurality of inputs, each input adapted to be coupled to a coaxial cable;
a plurality of down conversion channels, selectably coupled to the plurality of inputs, each down conversion channel programmable to down convert signals at a selected frequency from a selected one of the plurality of inputs; and
a spectrum analyzer, selectably coupled to the plurality of inputs, the spectrum analyzer adapted to measure power levels over a frequency spectrum for a selected one of the plurality of inputs, the spectrum analyzer including:
an input adapted to receive an input signal,
a mixer, coupled to the input, the mixer adapted to produce a down converted signal from the input signal,
an adjustable decimation circuit, coupled to the mixer, that selectively decimates the down converted signal,
a decoder, coupled to the adjustable decimation circuit, that measures power in the decimated signal, and
a control circuit, coupled to the mixer, that selectively controls the frequency of the down converted signals from the mixer to measure power over a frequency spectrum of the input signal.

31. The circuit of claim 30, and further including a memory, coupled to the decoder, that stores values related to the measured power.

32. The circuit of claim 30, and further including a numerically controlled oscillator, coupled to the mixer and to the control circuit, wherein the control circuit steps the numerically controlled oscillator through the plurality of frequencies.

33. The circuit of claim 30, wherein the adjustable decimation circuit includes:
a first stage, responsive to signals from the control circuit, the first stage selectively reducing the sampling rate of the down converted signal based on a characteristic of the input signal; and
a second stage, responsive to signals from the control circuit, the second stage selectively reducing the bandwidth of the down converted signal.

34. The circuit of claim 30, wherein the decoder measures the power by calculating a value based on I and Q components of the signal.

35. The circuit of claim 34, wherein the decoder calculates the value based on the equation:
Power=\sqrt{I²+Q²}

36. The circuit of claim 32, wherein the control circuit comprises a control circuit that establishes an initial control value, a number of steps and a step size for the control value provided to the numerically controlled oscillator.

37. The circuit of claim 30, wherein the decoder circuit further includes a log function that calculates a log of the measured power.

38. The circuit of claim 30, wherein a plurality of down conversion channels, selectably coupled to the plurality of inputs comprises a plurality of down conversion channels, multiplexed to the plurality of inputs wherein selectably coupled.

39. A digital down conversion circuit with a signal analyzer, the circuit comprising:
a plurality of inputs, each input adapted to be coupled to a coaxial cable;
a plurality of down conversion channels, selectably coupled to the plurality of inputs, each down conversion channel programmable to down convert signals at a selected frequency from a selected one of the plurality of inputs; and
a signal analyzer, selectably coupled to the plurality of inputs, the signal analyzer selectively providing at least one of frequency domain and time domain analysis of selected signals from the plurality of inputs.

40. An analysis system, comprising:
an input adapted to receive an input signal;
a mixer, coupled to the input, the mixer adapted to produce a down converted signal from the input signal;
a numerically controlled oscillator, coupled to the mixer, to provide a signal for down converting the input signal;
an adjustable decimation circuit, coupled to the mixer, that selectively decimates the down converted signal;
a decoder, coupled to the adjustable decimation circuit, that measures power in the decimated signal;
a memory, coupled to the decoder, that stores values related to the measured power; and
a control circuit, coupled to the numerically controlled oscillator and responsive to a processor, that selectively controls the frequency of the down converted signals from the mixer to measure power for at least one frequency range of the input signal based on values supplied by the processor.

41. The analysis system of claim 40, wherein the control circuit selectively generates control signals for the numerically controlled oscillator that step the numerically controlled oscillator through a plurality of frequencies.

42. The analysis system of claim 40, wherein the control circuit selectively generates a control signal for the numerically controlled oscillator to establish a frequency for time domain analysis.

43. The analysis system of claim 40, wherein the control circuit selects between stepping the numerically controlled oscillator through a plurality of frequencies and establishing a frequency for time domain analysis.

44. A signal analyzer, comprising:
an input adapted to receive an input signal;
a mixer, coupled to the input, the mixer adapted to produce a down converted signal from the input signal;
an adjustable decimation circuit, coupled to the mixer, that selectively decimates the down converted signal;
a threshold comparator, coupled to the adjustable decimation circuit, that compares the decimated signal with a selected threshold over a period of time; and
a control circuit, coupled to the mixer, that selectively controls the frequency of the down converted signals from the mixer to select a frequency of the input signal for time domain analysis.

45. The signal analyzer of claim 44, and further including a numerically controlled oscillator, coupled to the mixer and to the control circuit, wherein the control circuit selects a frequency for the numerically controlled oscillator.

46. The signal analyzer of claim 44, wherein the adjustable decimation circuit includes:
a first stage, responsive to signals from the control circuit, the first stage selectively reducing the sampling rate of the down converted signal based on a characteristic of the input signal; and
a second stage, responsive to signals from the control circuit, the second stage selectively reducing the bandwidth of the down converted signal.

47. The signal analyzer of claim 44, wherein the threshold comparator calculates a value based on I and Q components of the signal to compare with the threshold.

48. The signal analyzer of claim 44, wherein the decoder calculates the value based on the equation:
Value=|I|+|Q|

49. The signal analyzer of claim 44, wherein the threshold of the threshold comparator is selected based on expected power level and modulation technique.

50. The signal analyzer of claim 44, wherein the threshold comparator compares the decimated signal with the selected threshold over a symbol period.

51. A method for monitoring noise levels of an input signal at a selected frequency, the method comprising:
mixing the input signal to produce a down converted signal at the selected frequency;
decimating the down converted signal;
computing a value based on the decimated signal;
comparing the value with a threshold; and
monitoring the comparisons to provide time domain analysis of the signal.

52. The method of claim 51, wherein monitoring the comparisons comprises monitoring the comparisons to determine an estimate of the noise in the input signal.

53. The method of claim 51, wherein computing a value comprises computing a value according to the equation:
Value=|I|+|Q|

wherein I and Q comprise the in-phase and quadrature-phase components of the input signal.

54. The method of claim 51, wherein mixing the signal comprises mixing the signal under the control of a numerically controlled oscillator.

55. The method of claim 51, wherein computing a value based on the decimated signal comprises computing a value over a symbol period.

56. The method of claim 51, wherein monitoring the comparisons comprises tracking the number of times the computed value exceeds the threshold.

57. The method of claim 51, wherein comparing the value with the threshold comprises comparing the value with the threshold established based on one half of the distance between adjacent points in a constellation for a selected modulation.
